(19) United States
(12) Patent Application Publication
(10) Pub. No.: US 2024/0224937 A1
(43) Pub. Date: Jul. 11, 2024

(54) Pet Garment

(71) Applicant: Puphazit, LLC, Wynnewood, PA (US)

(72) Inventors: Jamie Lynn Kendall, Wynnewood, PA (US); John Michael Smaltz, Phoenixville, PA (US)

(73) Assignee: Puphazit, LLC, Wynnewood, PA (US)

(21) Appl. No.: 18/408,038

(22) Filed: Jan. 9, 2024

Related U.S. Application Data
(60) Provisional application No. 63/479,018, filed on Jan. 9, 2023.

(51) Int. Cl. A01K 13/00

(52) U.S. Cl. CPC A01K 13/006

(57) ABSTRACT

A pet garment includes a first panel that covers a back of a pet and a second panel that includes two leg openings, which receive front legs of the pet. A collar is fixedly coupled to the first panel and second panel and includes a first segment and a second segment and that extend around a portion of the pet's neck. A zipper is coupled to the collar and first panel and extends along the collar and at least partially along the first panel. A cover releasably covers a portion of the zipper that extends along the collar, and a fastener that includes a first cap is fixedly coupled to the cover and. A receiving socket is fixedly coupled to the first segment of the collar and the first segment of the collar has an elasticity that is less than an elasticity of the second segment.

### CROSS-REFERENCE TO RELATED APPLICATIONS

This application claims the benefit of U.S. Provisional Patent Application No. 63/479,018 filed Jan. 9, 2023 entitled “Pet Garment”, which is incorporated by reference herein in its entirety.

### TECHNICAL FIELD

The present disclosure generally relates to a pet garment for an animal and, more particularly, to a pet garment for providing environmental protection for a pet.

### SUMMARY

In one embodiment there is a pet garment including a first panel configured to cover a back of a pet, a second panel fixedly coupled to the first panel, the second panel including two leg openings configured to receive front legs of the pet, the second panel configured to cover a portion of a neck and chest of the pet, a collar fixedly coupled to the first panel and second panel, the collar including a first segment and a second segment and configured to extend around a portion of the pet's neck, a zipper coupled to the collar and first panel, the zipper extending along the collar and at least partially along the first panel, a cover releasably covering a portion of the zipper which extends along the collar, and a fastener including a first cap fixedly coupled to the cover and a receiving socket fixedly coupled to the first segment of the collar. The first segment of the collar may have an elasticity that is less than an elasticity of the second segment.

In some embodiments, the first segment comprises between about 5% to about 10% of a total length of the collar. In some embodiments, the first segment is directly coupled to a portion of the zipper. In some embodiments, the fastener is a spring snap ring fastener. In some embodiments, the cover has an elasticity that is less than the elasticity of the second segment of the collar. In some embodiments, the second segment of the collar is comprised of about 85% nylon and about 15% elastane. In some embodiments, the pet garment further includes a second cap fixedly coupled to the cover and spaced from the first cap.

In some embodiments, the first panel and second panel are comprised of different materials. In some embodiments, the two leg openings are configured to allow the front legs of a pet to pass through while not exposing additional areas of the pet. In some embodiments, the two leg openings are disposed at an angle relative to a top surface of the first panel, the angle being between about 5 degrees and about 15 degrees. In some embodiments, each of the two leg openings include an upper edge and a lower edge, the lower edge having a greater elasticity than the upper edge. In some embodiments, the two leg openings include an upper edge and a lower edge, the lower edge having a radius of curvature that is less than a radius of curvature of the upper edge. In some embodiments, the second panel has an elasticity that is greater than an elasticity of the first panel.

In another embodiment there is a pet garment including a first panel configured to cover a back of a pet and comprised of a fleece fabric, a second panel fixedly coupled to the first panel and comprised of an elastomeric material, the second panel including two leg openings configured to receive front legs of a pet while not exposing additional areas of the pet, the second panel configured to cover a portion of a neck and chest of the pet, a collar fixedly coupled to the first panel and a second panel, the collar including a first segment and a second segment and configured to cover a portion of the pet's neck, a zipper coupled to the collar and the first panel, the zipper extending from the collar and along a portion of a length of the first panel, a cover releasably covering a portion of the zipper which extends along the collar and a spring snap ring fastener including a first cap fixedly coupled to the cover and a receiving socket fixedly coupled to the first segment of the collar. The first segment of the collar and the cover may each have an elasticity that is less than an elasticity of the second segment.

In some embodiments, the first segment comprises between about 5% to about 10% of a total length of the collar. In some embodiments, the first segment is directly coupled to a portion of the zipper. In some embodiments, the second segment of the collar is comprised of about 85% nylon and about 15% elastane. In some embodiments, the first segment of the collar is comprised of a non-elastic material. In some embodiments, the pet garment further includes a second cap fixedly coupled to the cover and spaced from the first cap.

In another embodiment there is a pet garment including a first panel configured to cover a back of a pet, a second panel fixedly coupled to the first panel, the second panel including two leg openings configured to receive front legs of the pet, the second panel configured to cover a portion of a neck and chest of the pet, a collar fixedly coupled to the first panel and second panel, the collar including a first segment and a second segment and configured to extend around a portion of the pet's neck, and a double-sided zipper coupled to the collar and first panel and extending from the collar along a portion of a length of the first panel, the double-sided zipper including a first slider and second slider movable along the double-sided zipper independent of one another.

### BRIEF DESCRIPTION OF THE DRAWINGS

The following detailed description of embodiments of the pet garment, will be better understood when read in conjunction with the appended drawings of exemplary embodiment. It should be understood, however, that the invention is not limited to the precise arrangements and instrumentalities shown.

In the drawings:

FIG. 1 is a side view of a pet garment in accordance with an exemplary embodiment of the present invention shown in use on a dog;

FIG. 2 is a rear view of the pet garment of FIG. 1;

FIG. 3A is a magnified view of the collar of the pet garment of FIG. 1;

FIG. 3B is a magnified view of the collar of the pet garment of FIG. 1 with the cover pulled away from the collar;

FIG. 3C is a magnified view of the inner surface of the collar of the pet garment of FIG. 1;

FIG. 4A is a portion of the pet garment of FIG. 1 with a cover in accordance with another exemplary embodiment of the present invention;

FIG. 4B is a portion of the pet garment of FIG. 1 with the cover of FIG. 4A pulled away from the collar;

FIG. 5 is a portion of the pet garment of FIG. 1 with a cinch cord in accordance with another exemplary embodiment of the present invention;

FIG. 6 is a bottom view of the pet garment of FIG. 1;

FIG. 7 is a perspective view of the pet garment of FIG. 1;

FIG. 8 is a side view of the pet garment of FIG. 1;

FIG. 9 is a top perspective view of the pet garment of FIG. 1 shown in a flat configuration;

FIG. 10 is a top elevational view of the pet garment of FIG. 1 shown in a flat configuration;

FIG. 11 is a bottom elevational view of the pet garment of FIG. 1 shown in a flat configuration;

FIG. 12 is a left-side elevational view of the pet garment of FIG. 1 shown in a flat configuration;

FIG. 13 is a top plan view of the pet garment of FIG. 1 shown in a flat configuration and turned inside out;

FIG. 14 is a perspective view of a pet garment in accordance with another exemplary embodiment of the present invention;

FIG. 15 is a top elevational view of the pet garment of FIG. 14;

FIG. 16 is a bottom elevational view of the pet garment of FIG. 14;

FIG. 17 is a right-side elevational view of the pet garment of FIG. 14;

FIG. 18 is a left-side elevational view of the pet garment of FIG. 14; and

FIGS. 19A-19C, are perspective views of a portion of a pet garment in accordance with another exemplary embodiment of the present invention.

### DETAILED DESCRIPTION

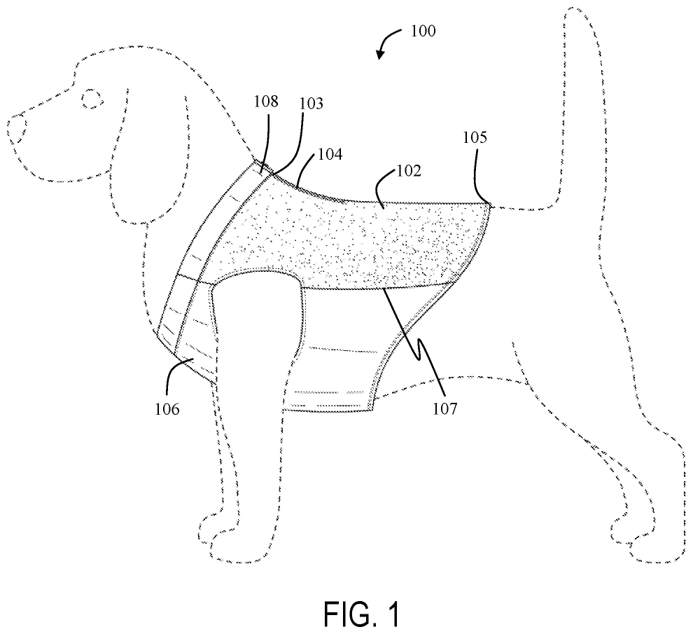

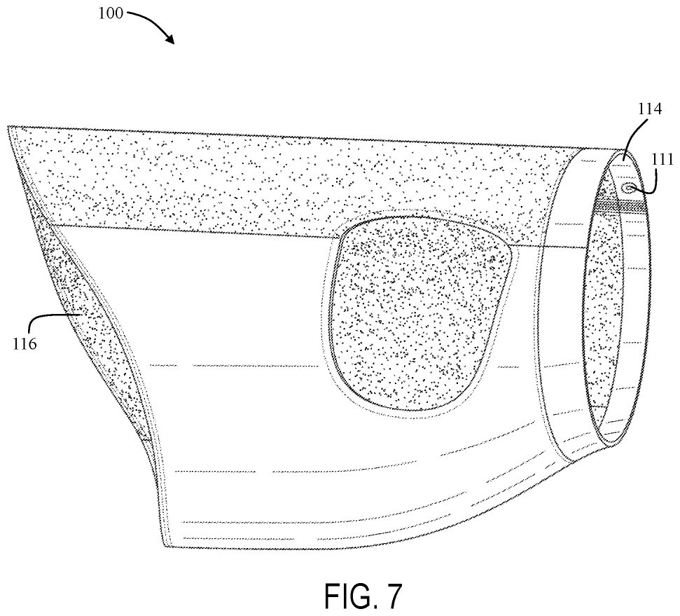

Referring to the drawings in detail, wherein like reference numerals indicate like elements throughout, there is shown in FIGS. 1-13 a pet garment, generally designated 100, in accordance with an exemplary embodiment of the present invention. The pet garment may be a vest or jacket to keep the pet warm and/or dry and/or for fashion purposes. The pet garments may include surfaces comprised of different materials such that the pet garment is able to expand and contract with the pet's movements while providing improved protection from weather conditions (e.g., rain, snow, low temperatures). The pet garments may include leg openings configured to form fit to the angle of the pet's shoulder while the pet is walking or running. The pet garments may include an integrated harness system configured to allow a user to attach a leash and/or lead to the pet garment.

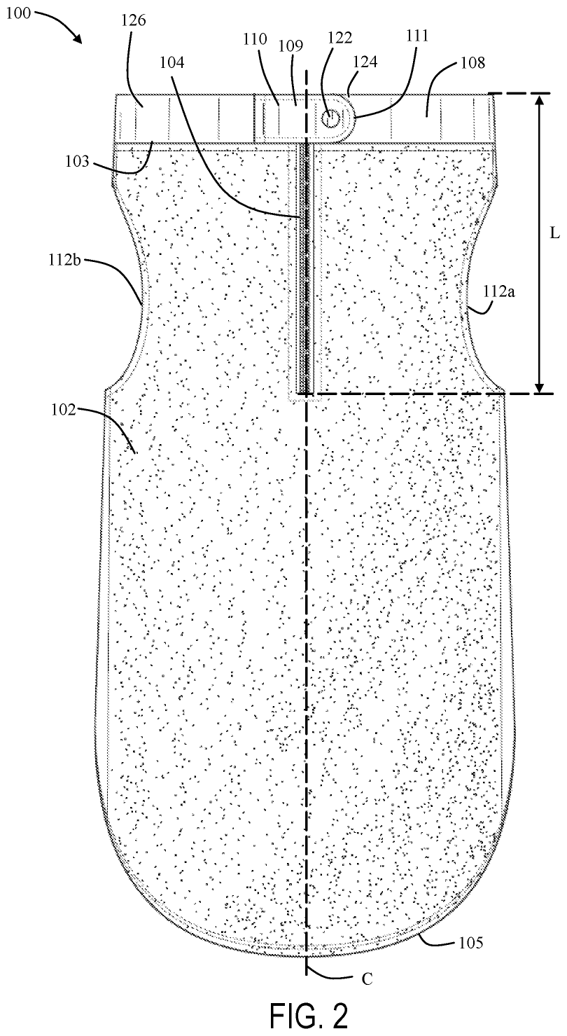

Referring to FIGS. 1-2, the pet garment 100 may include a first panel 102, a zipper 104 coupled to the first panel 102, a second panel 106 disposed below the first panel 102, and a collar 108 coupled to both the first panel 102 and second panel 106. The pet garment 100 may include two leg openings 112a, 112b configured to receive the front legs of a pet wearing pet garment 100. The first panel 102 may be configured to cover at least a portion of a pet and/or animal's back, sides, and/or nape. For example, the first panel 102 may be a fabric panel positioned on the pet garment 100 such that the first panel 102 at least partially cover the sides and back of a pet wearing the pet garment 100. In some embodiments, the first panel 102 includes a proximal end 103 configured to be positioned proximate the nape of a pet (e.g., a dog) when worn and a distal end 105 configured to be positioned proximate a rear end and/or tail of the pet when worn. The first panel 102 may extend from the proximal end 103 along a portion of the dog's back to the distal end 105. In some embodiments, the first panel 102 is sized to terminate proximate a pet's rear end and/or tail such that the rear end and/or tail is not covered by the first panel 102. In FIG. 1 the pet garment 100 is shown being worn by a dog, however it will be understood that the pet garment 100 may be worn by a different type of pet or animal such as, but not limited to, a cat, pig, lizard, or any other type of pet. In some embodiments, the size and/or shape of the pet garment 100 may be altered based on the size and shape of the pet intended to wear the pet garment. For example, the size of the pet garment 100 may be increased for larger pets and decreased for smaller pets.

The first panel 102 may be sized to extend from a back of a pet and wrap around it to where the pet's front legs meet its chest. For example, the hemline 107 of the first panel is configured to be positioned proximate a pet's shoulder when the pet garment 100 is worn by the pet. The hemline 107 may be generally located where the first panel 102 and second panel 106 are coupled to one another. For example, the first panel 102 is fixedly coupled to the second panel 106 at or proximate to the hemline 107. The hemline 107 may extend from the proximal end 103, along the sides of the pet garment 100 toward the distal end 105. The first panel 102 may have a length as measured from where a neck of a pet begins, along a portion of the pet's spinal column to a rear end of the pet. The first panel 102 may be configured to provide environmental protection to a pet placed in the pet garment 100. In some embodiments, the first panel 102 is comprised of a water and/or rain resistant material. In other embodiments, the first panel 102 may be another material that is coated in a water and/or rain resistant material. The first panel 102 may be comprised of a fleece material to provide protection from cold weather and/or rain when a pet is outdoors or exposed to corresponding environmental conditions. In some embodiments, the first panel 102 is comprised of a fleece fabric having about 400 grams per square meter weight. In some embodiments, the first panel 102 is comprised of a Tier 1, 400 grams per square meter (gsm) heavy fleece fabric. The fleece fabric may be comprised of 100% polyester, anti-piling material and have a soft texture while remaining durable for different weather conditions and/or use conditions. In some embodiments, the first panel 102 may be comprised of a different material that is more suitable to a different environmental condition. For example, the top portion 102 may be comprised of a material configured to dissipate heat.

The collar 108 may be configured to wrap around a portion of a neck and/or chest of a pet wearing the pet garment 100. The collar 108 may be coupled to the first panel 102 proximate where the first panel 102 meets a neck of the pet. For example, the collar 108 is coupled to the proximal end 103 of first panel 102. The collar 108 may be fixedly coupled to first panel 102. For example, the collar 108 may be stitched to first panel 102. In some embodiments, the collar 108 is double stitched to the second panel 106 and first panel 102. Collar 108 may be comprised of an elastomeric material. Collar 108 may include a cover 109 coupled to a portion of collar 108 near a back area of a pet's neck. Cover 109 may have a first end 110 which is fixedly coupled to collar 108 and a second end 111 which is releasably coupled to collar 108. The first end 110 of cover 109 may be stitched to collar 108. The second end 111 may include a fastener 122 for releasably coupling to collar 108.

The collar 108 may include a first segment 124 where the cover 109 and/or fastener 122 are located and a second segment 126 coupled to the first segment 124 and forming the remainder of the collar 108. In some embodiments, the first segment 124 and second segment 126 each include respective panel(s) of fabric that are fixedly coupled to one another. In some embodiments, the first segment 124 and second segment 126 are integrally formed. In some embodiments, the first segment 124 is directly coupled to the zipper 104. For example, the zipper 104 extends along the first segment 124 of the collar 108. In some embodiments, the first segment 124 is directly coupled to the first panel 102. The first segment 124 may be a portion of the collar 108 proximate the zipper 104 and the second segment 126 may be the remaining portion of the collar 108. In some embodiments, the first segment 124 comprises a portion of the collar 108 that extends partially along both sides of a central axis C of the pet garment 100. For example, the first segment 124 may extend from approximately where the cover 109 is coupled to the collar 108 toward the zipper 104 and from the zipper 104 away from the central axis C where a female mating feature of the fastener 122 is positioned. In some embodiments, the first segment 124 extends to either side of the zipper 104 by about 1.50 inches. In some embodiments, the first segment 124 encompasses a portion of the collar 108 on one side of the central axis C opposite where the first end 110 of the cover 109 is coupled to the collar 108. In some embodiments, the first segment 124 is configured to be proximate or directly contact the nape of a pet wearing the pet garment 100. In some embodiments, the first segment 124 comprises between 5-10% of the total length of the collar 108. In some embodiments, the first segment 124 comprises about 10% of the total length of the collar 108.

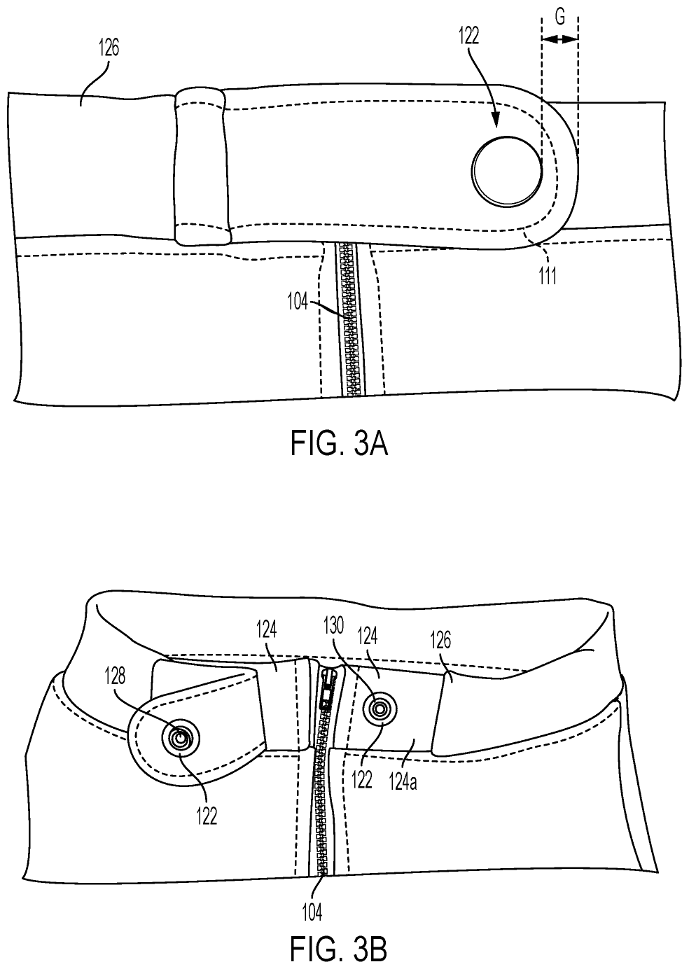

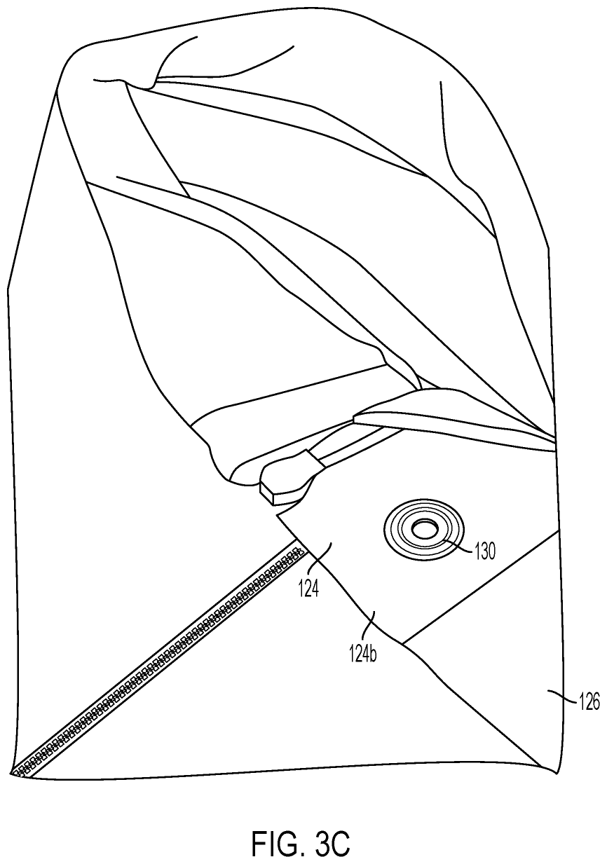

Referring to FIGS. 3A-3C, the first segment 124 of the collar 108 may be configured to reduce the risk of an accidental or unintended decoupling of the fastener 122 from the collar 108. The first segment 124 may be comprised of a material that is less elastic than the second segment 126. The first segment 124 may be comprised of a generally non-stretchable material and the second segment 126 may be comprised of a generally stretchable material. For example, the second segment 126 may be comprised of about 85% nylon, and about 15% elastane and/or may have a gsm of about 250. As such, the second segment 126 may be capable of stretching to match the contour, size, and/or shape of a pet's neck and/or chest. The first segment 124 may be comprised of 100% polyester microfiber. In some embodiments, the first segment 124 is comprised of a material that has an elasticity that is between about 60% to about 95% less than the elasticity of the second segment 126. In some embodiments, the first segment 124 is comprised of a material having an elasticity that is about 80% less than the elasticity of the second segment 126. In some embodiments, the first segment 124 is comprised of a faux-suede material. In some embodiments, the first segment 124 is comprised of a nylon microfiber material. In some embodiments, the first segment 124 is comprised of a nylon mesh material. In some embodiments, the first segment 124 is comprised of a non-elastic material. The first segment 124 may be comprised of a denim material, a generally low elastic microfiber, a silk-based polyester, or another polyester blend material. The first segment 124 may be configured to bend or flex to generally match the contour of a pet's neck while not substantially stretching. In some embodiments, the first segment 124 has a thickness as measured between a corresponding top surface 124a and a bottom surface 124b that is greater than the thickness of the second segment 126.

The fastener 122 may include a top 128, or cap 128, and a receiving socket 130 configured to releasably receive the cap 128. In some embodiments, the fastener 122 is a snap-fit fastener (e.g., a ring-spring snap fastener). The cap 128 may be fixedly coupled to the cover 109 proximate the second end 111 and the receiving socket 130 may be fixedly coupled to the first segment 124 of the collar 108. A top portion of the receiving socket 130 may be exposed at the top surface 124a of the first segment 124 (as shown in FIG. 3B) and a bottom portion of the receiving socket 130 may be exposed at the bottom surface 124b of the first segment 124 (as shown in FIG. 3C). In some embodiments, by directly coupling the receiving socket 130 to the first segment 124, the risk of an unintentional or accidental decoupling of the receiving socket 130 therefrom may be reduced as compared to an instance in which the receiving socket 130 is directly coupled to the second segment 126. As such, by providing a first segment 124 having a lower elasticity than the second segment 126 the receiving socket 130 may be securely coupled to the collar 108.

The cover 109 may be configured to securely and reliably couple the cap 128 to the cover 109. The cover 109 may be comprised of a material having a lower elasticity than the second segment 126 of the collar 108. For example, the cover 109 may comprised of the same material as the first segment 124. As such, the cover 109 may be configured to bend or flex to generally match the contour of a pet's neck while not substantially stretching. In some embodiments, the thickness of the cover 109 is greater than or equal to the thickness of the first segment 124. In some embodiments, the cap 128 is spaced from the edge of the cover 109 by a predetermined minimum distance. For example, a distance G between a periphery of the cap 128 and the periphery of the cover 109 may be between about 0.25 inches to about 0.375 inches. In some embodiments, the distance G is at least 0.25 inches. By spacing the cap 128 from the edge of the cover 109 by distance G, cover 109 may be easily gripped by a user to decouple the cap 128 from the receiving socket 130.

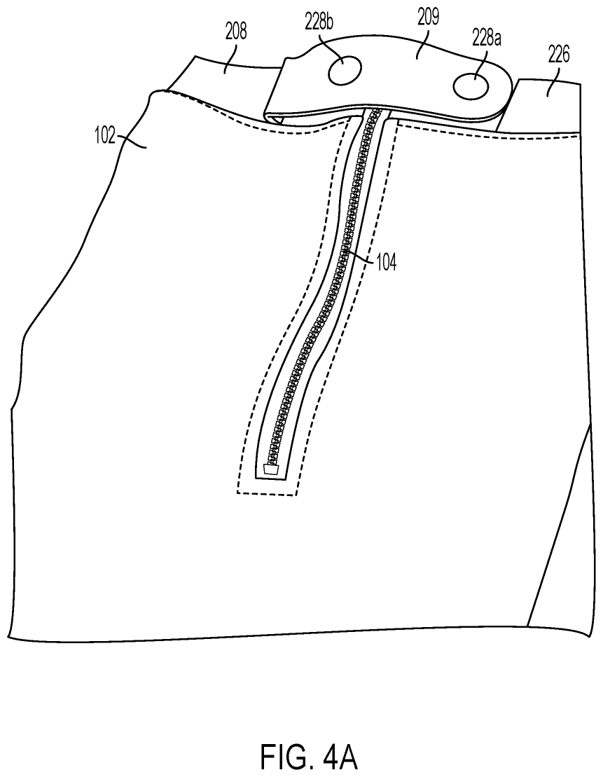

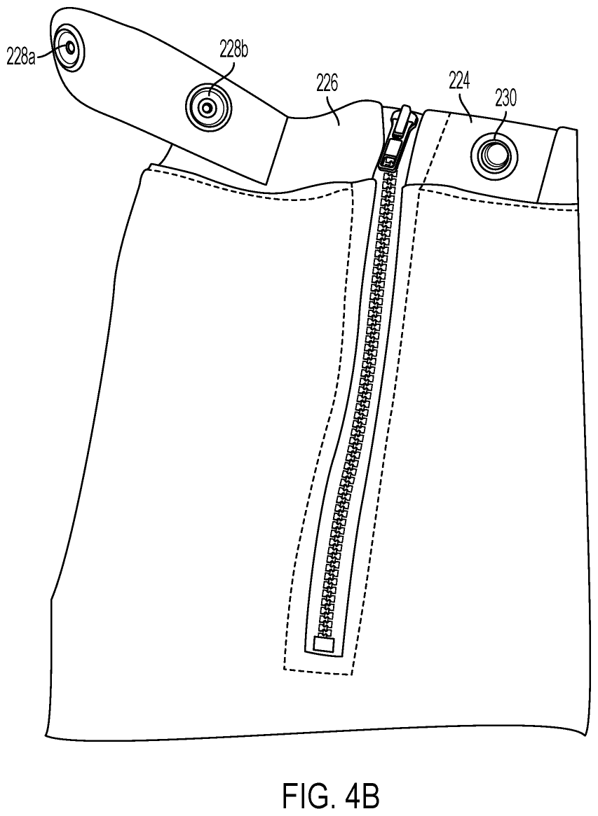

Referring to FIGS. 4A-4B, in some embodiments, the pet garment 100 may include an adjustable collar 208 configured to allow a user to adjust the size and/or shape thereof. The collar 208 may be substantially the same as collar 108 as described above except that it may include more than one cap 228 and/or corresponding receiving socket 230. For example, in FIGS. 4A-4B, there are two caps 228a-228b fixedly coupled to the cover 209 and there is one receiving socket 230 fixedly coupled to the first panel 224 of the collar 208. The caps 228a-228b and receiving socket 230 may be substantially the same as cap 128 and receiving socket 130 described above. By providing the two caps 228a-228b, a user may selectively couple one of the caps 228a-228b to the receiving socket 230 to selectively adjust the size and/or shape of the collar 208. For example, the collar 208 may be generally larger in radius when the first cap 228a is directly coupled to the receiving socket 230 than when the second cap 228b is directly coupled to the receiving socket 230. In this manner, a user may manually adjust the size of the collar 208 to better conform the size of the collar to their pet's neck (e.g., provide a more snug fit).

The first panel 224 of the collar 208 may be substantially the same as the first segment 124 described above. However, in some embodiments, there may be more than one receiving socket 230 coupled to the first panel 224 and as such, the first panel 224 may extend along a greater portion of the collar 208 than first segment 124. Similarly, the cover 209 may be generally the same as the cover 109 described above, except that the cover 209 may be longer in at least one direction (e.g., a direction generally perpendicular to the central axis C). Although, in FIGS. 4A-4B there are two caps 228a-228b and one receiving socket 230 shown, it should be understood that there may be a greater number of caps and/or receiving sockets coupled to the cover 209 and collar 208 respectively. For example, in some embodiments, there may be between two to five caps 228 and/or between two to five receiving sockets. In some embodiments, the number of receiving sockets coupled to the first panel 224 of the collar 208 is not equal to the number of caps coupled to the cover 209. In some embodiments, the number of receiving sockets is generally equal to the number of caps.

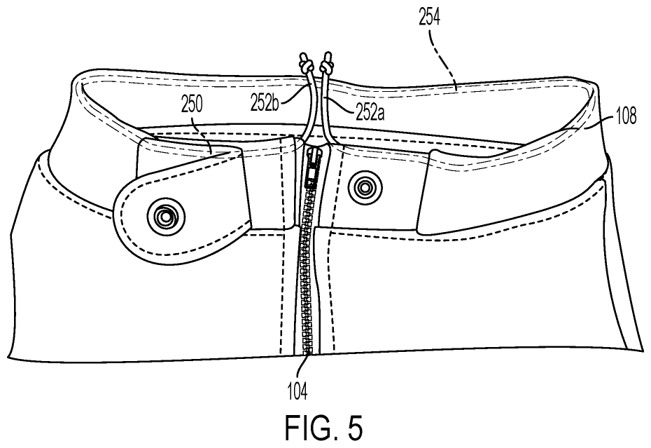

Referring to FIG. 5, in some embodiments, there may be a cinching cord 250 or cable positioned within the collar 108 and having opposed ends that are exposed exterior to the collar 108. For example, there may be a cinching cord 250 coupled to the collar 108 and including two terminal ends 252a-252b extending outwardly from the collar 108 and a central portion 254 extending between the two terminal ends 252a-252b. The terminal ends 252a-252b may extend outwardly from the collar 108 proximate the zipper 104. The central portion 254 of the cinching cord 250 may be substantially positioned between opposed fabric layers of the collar 108 such that it is covered by the collar 108. For example, the dash-dash broken lines in FIG. 5 are intended to represent the central portion 254 of the cinching cord 250 that are enclosed within the collar 108. As such, the central portion may be obscured from a user's vision by the collar 108. The cinching cord 250 may be moveable relative to the collar 108 such that a user may pull on either, or both, terminal ends 252a-252b to create a cinching effect around the collar 108. In this manner, the user may be able to manually adjust the size and/or shape of the collar 108 to better match the size and/or shape of a pet's neck. In some instances, an embodiment of the pet garment 100 including a cinching cord 250 may not include the cover 109 and/or fastener 122. In other embodiments, the pet garment 100 may include both a cinching cord 250, cover 109 and fastener 122 as shown in FIG. 5. In some embodiments, the cinching cord 250 is comprised of one or more of a polyester fabric blend, or a combination of microfiber backed fleece and a cotton polyblend trim.

Referring back to FIGS. 1-2, the zipper 104 may be configured to assist in placing a pet in pet garment 100. The zipper 104 may be coupled to the first panel 102 and collar 108 and extending along central axis C. In some embodiments, the zipper 104 extends along a portion of the length of first panel 102 as measured along the central axis C. For example, the zipper may extend along central axis C, from the collar 108 by a length L. The length L of zipper 108 may be between about 6 inches and about 10 inches. For example, the length L may be about 6 inches, about 6.5 inches, about 7 inches, about 7.75 inches, or about 9.75 inches. In other embodiments, the zipper 104 extends along the entire length of first panel 102. The zipper 104 may extend from the first panel 102 across collar 108. The zipper 104 may extend along a width of collar 108. The zipper 104 may be configured to be in one or more open position (not shown) and a closed position (FIG. 2). For example, the zipper 104 may include a slider (not shown) configured to selectively lock the zipper 104 in a closed position and a plurality of open positions. In some embodiments, the zipper 104 is a multi-position locking zipper configured to be locked in one or more positions between the open position and the closed position by the slider.

The zipper 104, when in an open position, may allow the ends of collar 108 and a portion of first panel 102 to open such that a pet's head can more easily pass through than if the zipper 104 was in the closed position. The zipper 104, when in the closed position, may help to prevent heat from escaping the garment and/or unintended removal of the pet garment 100 from the pet. In some embodiments, the zipper 104 may be locked in an open position to allow the pet garment 100 to be worn by pets having various head sizes. The zipper 104 may be configured to provide access to a leash or harness worn under the pet garment 100. In some embodiments, the zipper 104 may be locked in an open position to allow for a connection of a leash to a harness worn by a pet, under the pet garment 100.

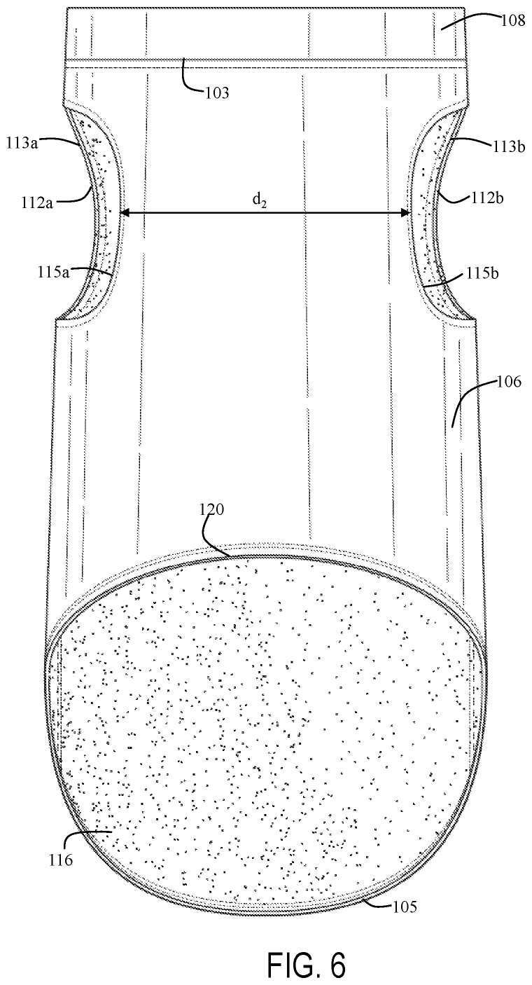

In some embodiments, the cover 109 is configured to cover the portion of the zipper 104 which extends along the length of collar 108. In some embodiments, the cover 109 extends over and at least partially conceals a slider that is coupled to zipper 104. The slider may be configured to provide a gripping surface for a user to manually open or close zipper 104. In one embodiment, the zipper 104 is a #3 nylon coil zipper. In other embodiments, the zipper 104 is a #5 nylon coil zipper. The left side of the pet garment is shown in FIG. 1, however the right side may be symmetrical in appearance to the left side with regards to the first panel 102, zipper 104, and second panel 106. In some embodiments, the zipper 104 may include one or more buffer flaps (not shown) disposed on an interior side of the zipper 104 prevent the skin and/or fur of a pet wearing the pet garment 100 from being closed within or pulled into the zipper 104 during operation of zipper 104. In some embodiments the buffer flap is comprised of a fleece material. Referring to FIGS. 6-8, the second panel 106 of pet garment 100 may be fixedly coupled to the first panel 102. In some embodiments, the second panel 106 and first panel 102 are stitched together along hemline 107. In some embodiments, the first panel 102 and second panel 106 are double stitched to one another along hemline 107, thereby increasing the durability of the pet garment 100. The second panel 106 may be configured to cover a portion of a pet's neck and/or chest. The second panel 106 may be comprised of a material different than the material that the first panel 102 is comprised of. In some embodiments, the second panel 106 is comprised of an elastomeric material. In some embodiments, the second panel 106 is comprised of a generally stretchable material. In some embodiments, second panel 106 is comprised of a material having a higher elasticity than the material used in the first panel 102. In some embodiments, the second panel 106 may be comprised of about 85% nylon, and about 15% elastane. In some embodiments, the second panel 106 is comprised of a material having a gsm of about 250. In some embodiments, the second panel 106 may include an outer surface 118 and an inner surface (not shown). The inner surface may contact a pet's body when the pet is wearing pet garment 100. The outer surface 118 may face away from a pet when the pet is wearing pet garment 100. In some embodiments, the outer surface 118 is a water repellent outer surface. In some embodiments, the inner surface includes a fleece and/or felt fabric.

The pet garment 100 may include leg openings 112a and 112b configured to receive the front legs of a pet wearing pet garment 100. In some embodiments, the leg openings 112a, 112b have a semi-circular shape. The leg openings 112a, 112b may include an upper edge 113a, 113b that extends above the hemline 107 toward the first panel 102, and a lower edge 115a, 115b that extends below the hemline 107 toward the second panel 106. The upper edges 113a, 113b may be generally curved and the lower edges 115a, 115b may also be generally curved. The upper edge 113a, 113b may have a radius of curvature that is greater than the radius of curvature of the corresponding lower edge 115a, 115b. In other embodiments, the leg openings 112a, 112b have a semi-circular shape with a generally D-shape perimeter (e.g., a semi-circle with flattened sides). For example, the leg openings 112a and 112b each include a corresponding upper edge 113a and 113b and a lower edge 115a, 115b. In other embodiments, the leg openings 112a, 112b are another shape such as an oval, rectangle, circle, square, or a trapezoidal shape.

Leg openings 112a and 112b may be configured to allow the front legs of a pet to pass through while not exposing additional areas of the pet. For example, the upper edges 113a and 113b may be comprised of the same material as the first panel 102 and the lower edges 115a and 115b may be comprised of the same material as the second panel 106. The second panel 106 is more elastic than the first panel 102 thereby allowing the legs of the pet to pass through the openings 112a and 112b while note exposing additional areas of the pet. In other words, the lower edges 115a and 115b may stretch to conform to the shape of the pet's legs. In some embodiments, the size and/or location of the leg openings may be altered to accommodate pets of a different size. For example, the leg openings 112a, 112b may be moved closer to or further away from the collar 108 depending on the relative location of the pet's legs and the size of the openings may be increased or decreased based on the size of the pet's shoulders.

In some embodiments, the leg openings 112a, 112b are configured to prevent bunching and/or gaping at the point of articulation for a pet's legs while the pet is walking or running. For example, the upper edges 113a and 113b being comprised of the same material as the first panel 102 may prevent the upper edges 113a and 113b from stretching while the pet is walking or running. Additionally, the lower edges 115a and 115b being comprised of the same material as the second panel 106 may allow the lower edges 115a and 115b to stretch while the pet is walking or running. The combination of the upper edges 113a and 113b not stretching and the lower edges 115a and 115b stretching, during walking or running, may prevent bunching and/or gaping at the point of articulation for the pet's legs while the pet is walking or running.

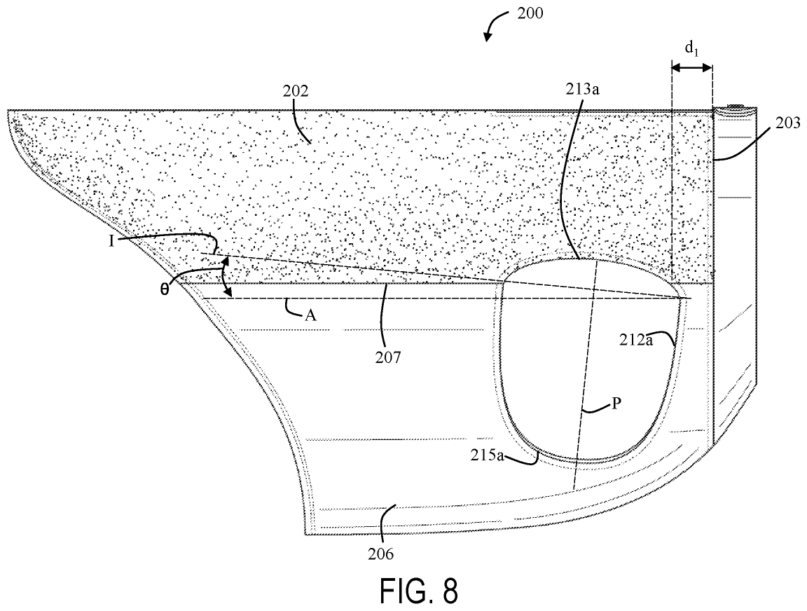

In some embodiments, both leg opening 112a and 112b are configured to form fit to an angle of a pet's shoulder angle while the pet is walking or running. For example, an axis I may be drawn between the two points where the upper edge 113a lower edge 115b meet, as shown in FIG. 8. The leg opening 112a may be oriented relative to the collar 108 and/or the top surface of the pet garment 100 based on the axis I. For example, there may be an axis P, perpendicular to axis I and centered between the two points where the upper edge 113a and lower edge 115b meet. The perpendicular axis P may intersect the peak of the upper edge 113a and the valley of the lower edge 115a. As such, the leg openings 112a and 112b may be disposed at an angle relative to the top surface of the pet garment 100 and/or relative to the collar 108. In this example, the top surface of the pet garment 100 is referenced. The axis I may be at an angle θ relative to a top surface of the pet garment 100. A top surface of the pet garment 100 may refer to a surface where central axis C shown in FIG. 2 lies and that is generally parallel to the axis A shown in FIG. 8. Although only leg opening 112a is shown in FIG. 8, it will be understood that leg opening 112b, on the opposite side of the pet garment 100 has substantially the same configuration.

By providing the upper edge 113a at angle θ, the leg opening 112a may form fit to the angle of the pet's shoulder while the pet is walking or running. In some embodiments the angle θ may be about 10 degrees. In other embodiments, the angle θ may be between about 5 degrees to about 10 degrees. The angle θ may correspond to the physical characteristics of one of the seven major dog groups: working, herding, toy, hound, sporting, non-sporting, terrier. For example, the pet garment 100 may be sized for one of the above dog groups, such as the terrier. As such, the angle θ would correspond to the angle of the terrier's shoulder. In some embodiments, the angle θ may have a direct correlation to the size of the dog. For example, a pet garment 100 sized for a larger breed of dog may include an angle θ (e.g., 8-10 degrees) of the leg openings 112a, 112b that is greater than the angle θ (e.g., 5-7 degrees) of the leg openings 112a, 112b for a pet garment 100 sized for a smaller dog.

In some embodiments, the upper edge 113a and 113b are each positioned along the corresponding hemline 107 a distance d₁ from the proximal end 103 of the first panel 102. The distance d₁ may correspond to the distance from the nape of the pet to the should of the pet such that the leg openings 112a and 112b are aligned with the pet's shoulder when the pet garment 100 is worn. As such, it will be understood that the distance d₁ between the proximal end 103 and upper edge 113a, 113b of the leg openings 112a and 112b may be altered (e.g., reduced or increased) such that the leg openings 112a and 112b align with the shoulder of various pets of different size. Leg openings 112a, 112b may be disposed opposite one another on second panel 106. Leg openings 112a, 112b may be spaced apart from one another by a distance d₂ corresponding to the distance between the front legs of a dog. Leg openings 112a and 112b may be disposed opposite one another on second panel 106. Leg openings 112a and 112b may be spaced apart from one another by a distance d₂ corresponding to the distance between the front legs of a dog.

The upper edges 113a and 113b of leg openings 112a, 112b may be disposed proximate first panel 102. The lower edges 115a and 115b of leg openings 112a, 112b may extend away from first panel 102 along an area of second panel 106. Leg openings 112a, 112b may be positioned between the openings in the pet garment 100 that are configured to receive a pet's neck and rear (e.g., first opening 114 and second opening 116 discussed below). In some embodiments, leg openings 112a, 112b are reinforced leg openings. In some embodiments, the leg openings 112a, 112b include stitching (e.g., double stitching) around the perimeter of the leg openings 112a, 112b for added durability. In some embodiments, the leg openings 112a, 112b include a reinforced hemming to allow for a comfortable and functional fit for a pet wearing pet garment 100.

The second panel 106 may include a tapered section 120 to allow for a pet wearing pet garment 100 to urinate without requiring that the pet garment 100 be removed. In some embodiments, the tapered section 120 is a double stitched tapered section. In some embodiments, the collar 108 may define a first opening 114 disposed at a proximal end of pet garment 100. The first opening 114 may be configured to receive the head and/or neck of a pet wearing the pet garment 100. In some embodiments, the first panel 102 and second panel 106 may define a second opening 116 at a distal end of pet garment 100. The second opening 116 may be configured to allow a rear end of the pet, including a tail, a portion of the pet's back and/or the pet's rear legs to extend distally from opening 116. The pet garment 100 may have a generally frustoconical shape. For example, the pet garment 100 has a generally frustoconical shape flaring outwardly from the neck opening (e.g., first opening 114) to the rear opening (e.g., second opening 116).

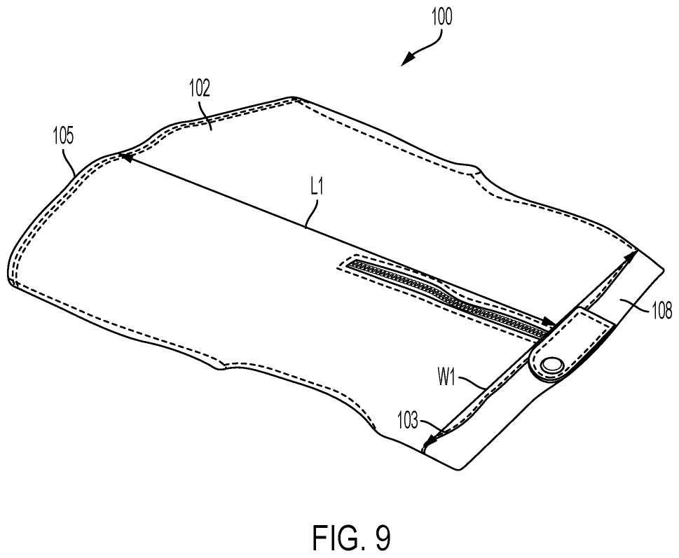

Referring to FIGS. 9-13, there are shown various views of the pet garment 100 in a flat configuration. As discussed above, the pet garment 100 may be sized to fit a plurality of different breeds of dogs and/or other animals. As such, the dimensions of the pet garment 100 may vary. The various dimensions of the pet garment 100 will be discussed with reference to FIGS. 9-13 and it should be understood that the dimensions discussed herein are based on the pet garment being in a generally flat or unworn configuration. Referring to FIG. 9, the collar 108 may have a width W1 of between about 5.25 inches to about 8.25 inches with a tolerance of about +/−0.375 inches. In some embodiments, the width W1 is about 5.25 inches, about 6.25 inches, about 7.25 inches, or about 8.25 inches. In some embodiments, the length L1 of the first panel 102 may be between about 9.5 inches to about 15.5 inches with a tolerance of about +/−0.375 inches. In some embodiments, the length L1 is about 9.5 inches, 11.5 inches, 13.5 inches, or 15.5 inches.

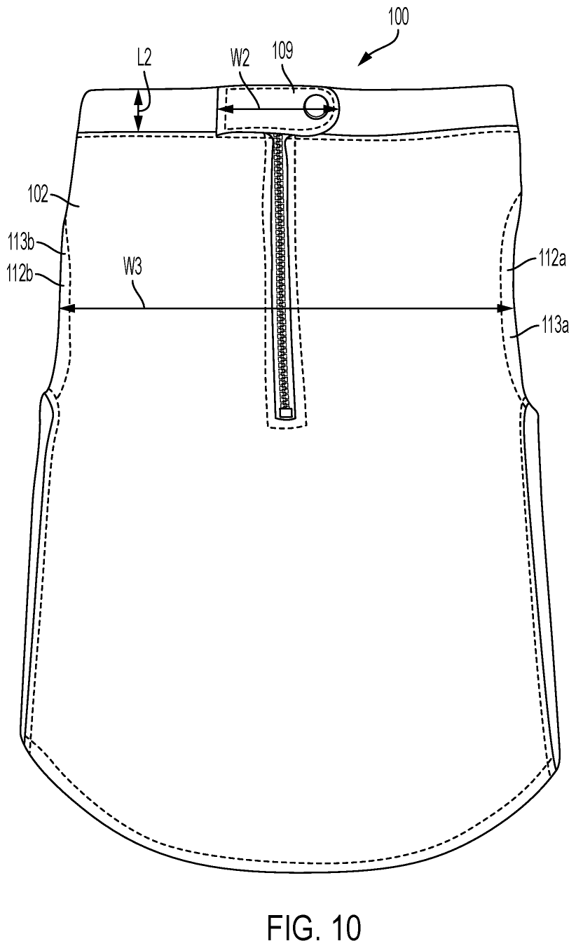

Referring to FIG. 10, the length L2 of the collar 108 may be between about 1.00 inches to about 1.25 inches with a tolerance of +/−0.25 inches. The width W2 of the cover 109 may be about 3.0 inches with a tolerance of +/−0.25 inches. The width W3 between the leg openings 112a, 112b (as measured between a center point at the upper edges 113a, 113b) may be between about 6.25 inches to about 9.5 inches with a tolerance of about 0.375 inches. In some embodiments, the width W3 is about 6.25 inches, about 7.5 inches, about 8.75 inches or about 9.5 inches.

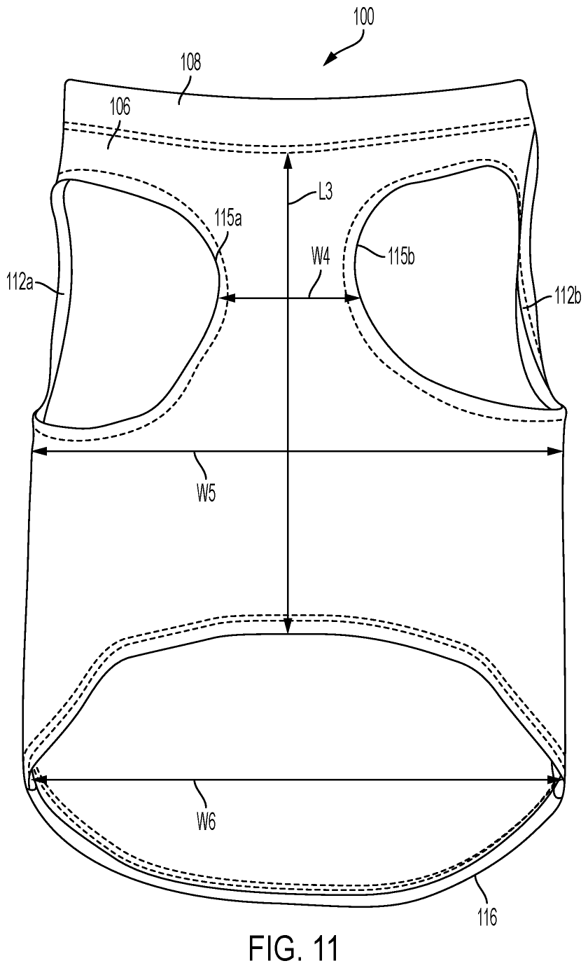

Referring to FIG. 11, the length L3 of the second panel 106 as measured from the point where the second panel 106 is between about 5.5 inches to about 9.0 inches with a tolerance of about +/−0.375 inches. In some embodiments the length L3 is about 5.5 inches, about 6.5 inches, about 7.5 inches, or about 9.0 inches. The width W4 between the leg openings 112a, 112b (as measured between a center point at the lower edges 115a, 115b) is between about 3.0 inches to about 3.25 inches with a tolerance of about +/−0.25 inches. In some embodiments, the width W5 of the second panel 106 configured to be proximate the pet's chest or belly (e.g., below the leg openings 112a, 112b) is between about 6.125 inches to about 10.25 inches with a tolerance of about +/−0.375 inches. In some embodiments, the width W5 is about 6.125 inches, about 7.5 inches, about 8.875 inches, or about 10.25 inches. In some embodiments, the width W6 of the second opening 116 (e.g., as measured between where the first and second panels contact one another 102, 106) is between about 6.75 inches to about 10.875 inches with a tolerance of about +/−0.375 inches. In some embodiments, the width W6 is about 6.75 inches, about 8.125 inches, about 9.5 inches, or about 10.875 inches.

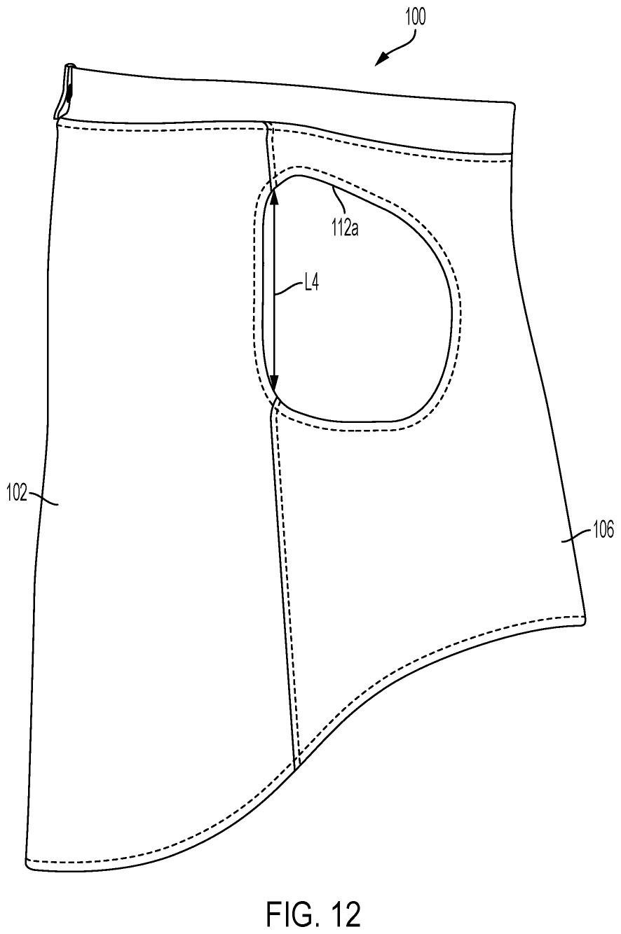

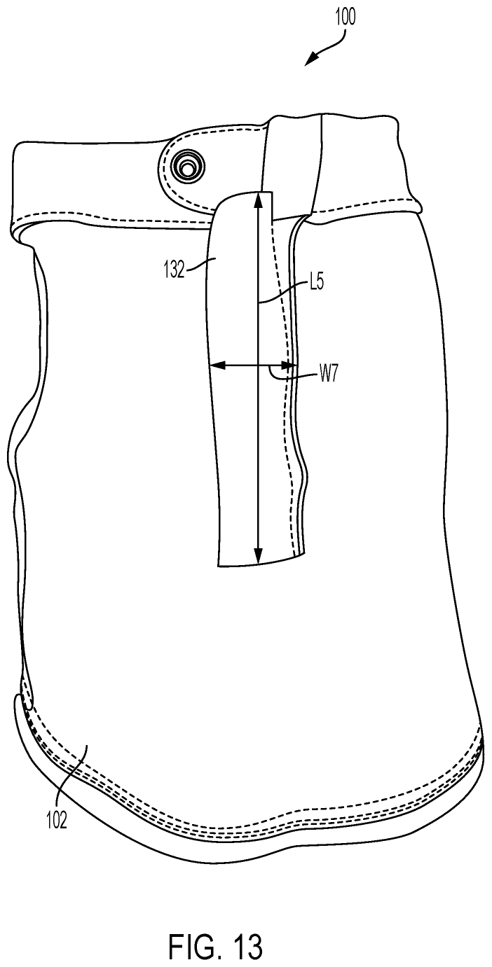

Referring to FIG. 12, the length L4 of the leg opening 112a, and leg opening 112b although not shown, is between about 2.25 inches to about 3.75 inches with a tolerance of about +/−0.375 inches. In some embodiments, the length L4 is about 2.25 inches, 2.75 inches, 3.25 inches, or about 3.75 inches. Referring to FIG. 13, the pet garment 100 is shown folded inside out such that the zipper guard 132 is visible. The zipper guard 132 may be a sheet of fabric or material that is configured to be positioned between a pet wearing the pet garment 100 and the zipper 104. In some embodiments, the zipper guard 132 may be comprised of the same material as the first panel 102. In some embodiments, the zipper guard 132 is fixedly coupled to the first panel 102. In some embodiments, at least one edge or surface of the zipper guard 132 is not fixedly coupled to the first panel 102 such that it may be moved. For example, at least one edge of the zipper guard 132 may not be stitched to the first panel 102. In some embodiments, the zipper guard 132 has a length L5 of about 6 inches, about 6.5 inches, about 7 inches, about 7.75 inches, or about 9.75 inches and a width W7 of about 0.50 inches.

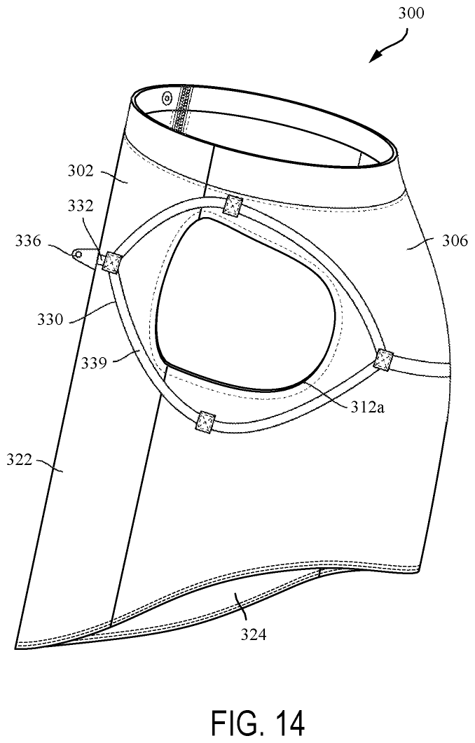

Referring to FIGS. 14-18, there is shown a pet garment, generally designated 300, in accordance with another exemplary embodiment of the present invention. The pet garment 300 may be generally the same as pet garment 100 shown in FIGS. 1-13 except that there may be harness 330 coupled to the pet garment 300. The harness 330 may be configured to allow a user to attach a leash or lead to the harness 330 to control the movement of a pet wearing the pet garment 300. The harness 330 may include a series of straps, or webbing, that loop around the pet's legs, chest, and/or back such that, a user may restrain or control movement of the pet wearing the pet garment 300. In some embodiments, one or more of the straps that are included in the harness 330 are coupled to an exterior surface 322 of the pet garment 300. For example, the straps included in the harness 330 may extend along the exterior surface 322 from the first panel 302 of the pet garment 300, to the second panel 306, and around and between the leg openings 312a, 312b. In this manner, the straps included in the harness 330 may be exposed, or visible, at the exterior surface 322 of the pet garment 300.

In other embodiments, the straps that are included in the harness 330 are coupled to the pet garment 300 such that they are interior to the exterior surface 322. For example, the pet garment 300 may include an interior surface 324 comprised of one or more layers of fabric and/or material and the exterior surface 322 may be comprised of one or more other layers of fabric and/or material. The straps included in the harness 330 may be positioned between the interior surface 324 and the exterior surface 322 (e.g., positioned between the layers of the interior surface 324 and exterior surface 322). In this manner the straps included in the harness 330 may be at least partially hidden from view. In some embodiments, the straps that are included in the harness 330 are coupled to and protrude from the interior surface 324. Put another way, the straps included in the harness 330 may be positioned between the body of the pet and the interior surface 324 of the pet garment 300 when worn by the pet. In some embodiments, the straps included in the harness 330 are fixedly coupled (e.g., stitched to) one or more of the interior surface 324 and exterior surface 322 of the pet garment 300.

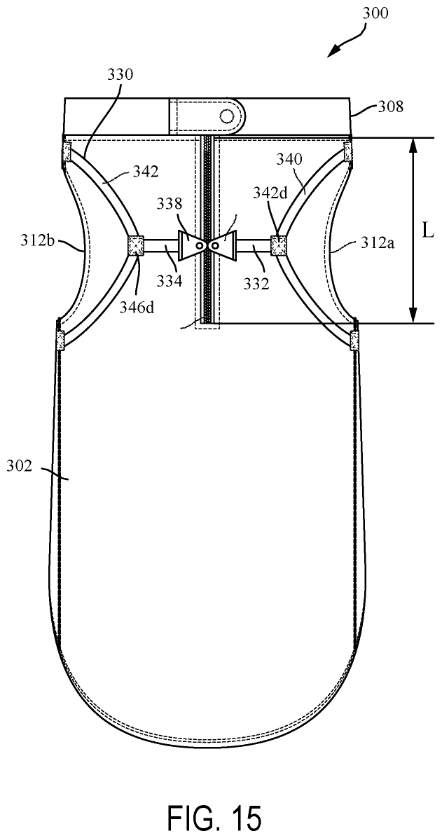

In some embodiments, the harness 330 includes at least one strap configured to couple a leash to the harness 330. The at least one strap configured to couple the leash to the harness 330 may be positioned on the pet garment 300 such that it is proximate a back of the pet when the pet is wearing the pet garment 300. In some embodiments, the harness 330 includes a first back strap 332 and a second back strap 334 each coupled to a respective first attachment element 336 and a second attachment element 338 (shown in FIG. 15). In some embodiments, the first back strap 332 and second back strap 334 are not directly coupled to one another such that a terminal end of each (e.g., where the attachment elements 336, 338 are coupled thereto) may be moved or adjusted by a user. For example, a user may wish to move or adjust the first back strap 332 and/or second back strap 334 such that the user may freely operate zipper 304. As shown in FIG. 13, the zipper 304 extends along first panel 302 of the pet garment 300 by a length L, generally the same as pet garments 100, and 200. The length L of the zipper 304 is great enough such that at least one of the back straps 332, 334 and/or attachment elements 336, 338 may partially obscure the zipper 304. As such, the back straps 332, 334 may not be directly coupled to one another to allow the user to move the back straps 332, 334 and/or attachment elements 336, 338 away from the zipper 304 so that the zipper 304 is not obscured.

In other embodiments, the zipper 304 may be sized such that the first back strap 332, second backstrap 334, first attachment element 336, and/or the second attachment element 338 does not obscure the zipper 304. For example, the zipper 304 may extend along the first panel 302, from the collar 308 a length that is less than length L such that the zipper 304 is not obscured by the first back strap 332, second back strap 334, first attachment element 336, and/or second attachment element 338. In some embodiments, the first back strap 332 and second back strap 334 may be directly coupled to one another. For example, the first back strap 332 and second back strap 334 may be a single continuous strap. In some embodiments, the first back strap 332 and second back strap 334 are at least partially fixedly coupled to the pet garment 300. For example, at least a portion of each of the first back strap 332 and second back strap 334 may be stitched to the pet garment 300.

In embodiments where the harness 330 is positioned between the exterior surface 322 and interior surface 324 of the pet garment, the first back strap 332 and/or second back strap 334 may extend from below the exterior surface 322 to above the exterior surface 322 such that the attachment elements 336, 338 may be accessed by a user. For example, there may be one or more openings (not shown) along the exterior surface 306 of the first panel 302 of the pet garment 300 such that the back straps 332, 334 may extend therethrough. In this manner, the back straps 332, 334 may extend partially above the exterior surface 322 of the pet garment 300 while the remaining portions of the harness 330 remain disposed between the exterior surface 322 and interior surface 324. In embodiments, where the harness 330 is positioned interior to the interior surface 324 of the pet garment, the first back strap 332 and/or second back strap 334 may extend from a position interior to the interior surface 324, to a position exterior to the exterior surface 322 such that the attachment elements 336, 338 may be accessed by a user.

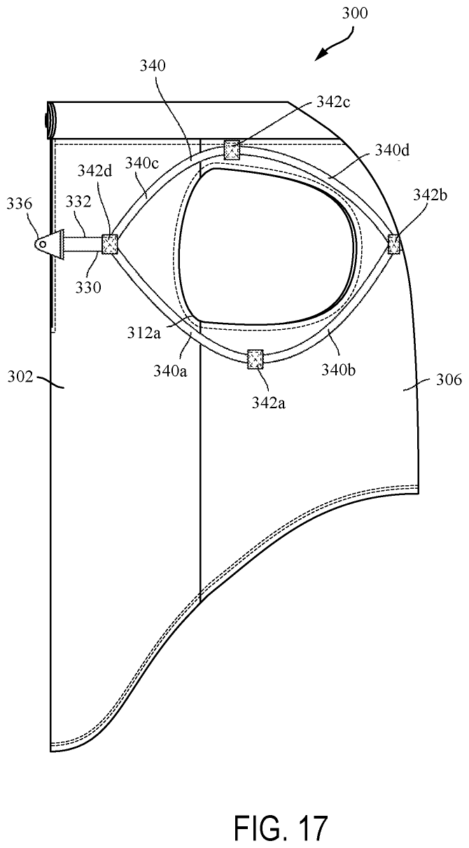

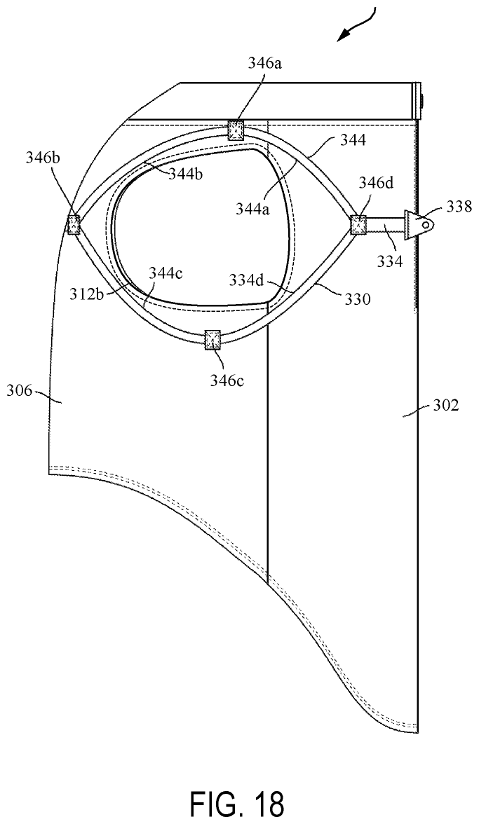

In some embodiments, the harness 330 may include a first set of leg straps 340 and a second set of leg straps 344 each configured to allow the front legs of a pet wearing the pet garment 300 to extend therethrough. The first set of leg straps 340 may be positioned proximate the first leg opening 312a (shown in FIG. 17) of the pet garment 300 and the second set of leg straps 344 may be positioned proximate the second leg opening 312b (shown in FIG. 18). The first set of leg straps 340 may be generally proximate to and extend around the first leg opening 312a. In some embodiments, the first set of leg straps 340 do not extend across the leg opening 312a. For example, the first set of leg straps 340 may be positioned proximate the first leg opening 312a and may extend around a periphery of the leg opening 312a without extending across the periphery of the leg opening 312a.

In some embodiments, the first set of leg straps 340 includes one or more straps coupled one to another. For example, the first set of leg straps 340 may include a first strap 340a, a second strap 340b, a third strap 340c, and a fourth strap 340d. The first strap 340a may be coupled to the second strap 340b at a coupling location 342a, the second strap 340b may be coupled to the third strap 340c at a coupling location 342b, the third strap 340c may be coupled to the fourth strap 340d at a coupling location 342c, and the fourth strap 340d may be coupled to the first strap 340a at a coupling location 342d. The coupling locations 342a-342d may be an area on the pet garment 300 that includes reinforced padding and/or stitching that is configured to secure the position of the first set of leg straps 340 relative to the first leg opening 312a. For example, at each coupling location 342a-342d, there may be stitching that fixedly couples the straps 340a-340d one to another. In this manner, coupling locations 342a-342d may at least partially define the orientation and position of the corresponding straps 340a-340d relative to the leg opening 312a. In some embodiments, the straps 340a-340d are double stitched to each other at the respective coupling locations 342a-342d. In some embodiments, there are more than four coupling locations 342 and straps included in the first set of leg straps 340.

In some embodiments, at least one of the straps 340a-340d is integrally formed with at least one other of the straps 340a-340d. For example, the first strap 340a and second strap 340b may be a single integrally formed strap that is fixedly coupled to the pet garment 300 at coupling locations 342a, 342b, and 342d. Similarly, the third strap 340c and fourth strap 340d may be a single integrally formed strap that is fixedly coupled to the pet garment 300 at coupling locations 342b-342d. In some embodiments, at least one of the straps 340a-340d may include stitching that extends along the respective strap 340a-340d and between the corresponding two coupling locations 342a-342d. For example, the first strap 340a may include stitching that extends along the length of the first strap 340a and between coupling locations 342a and 342d. It will be understood that the first set of leg straps 340 illustrated in FIG. 15 is an example and that there may be more or fewer than four straps may be included there may be more or fewer than four corresponding coupling locations included in the first set of leg straps 340. In some embodiments, the first back strap 332 is coupled to the first set of leg straps 340. For example, the first back strap 332 may be fixedly coupled to the first set of leg straps 340 at the coupling location 342d.

The second set of leg straps 344 (shown in FIG. 18) may be generally the same as the first set of leg straps 340. For example, the second set of leg straps 344 may include a first strap 344a, second strap 344b, third strap 344c, and fourth strap 344d coupled to one another at corresponding coupling locations 346a-346d generally the same as straps 340a-340d and coupling locations 342a-342d. As such, for sake of brevity and so as not to obscure aspects of the present invention, the second set of leg straps 344 will not be described in full detail. It will be understood that the description of the first set of leg straps 340, and the features thereof, applies to the second leg straps 344. It will also be understood that the description of the first set of leg straps 340 in relation to the first leg opening 312a may be generally the same as the description of the second set of leg straps 344 in relation to the second leg opening 312b. It will further be understood that the description of the first set of leg straps 340 in relation to the first back strap 332 is generally the same as the description of the second set of leg straps 344 in relation to the second back strap 334.

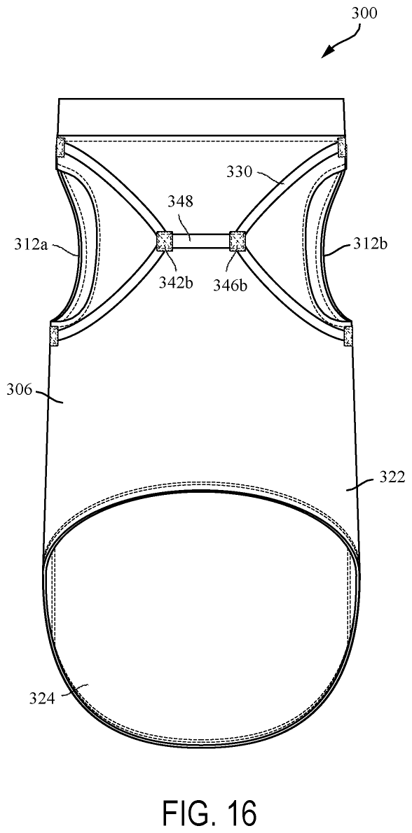

In some embodiments, the harness 330 includes a chest strap 348 (shown in FIG. 16) configured to extend across at least a portion of a pet's chest when the pet is wearing the pet garment 300. The chest strap 348 may be coupled to and extend between the first set of leg straps 340 and the second set of leg straps 344. For example, the chest strap 348 may be fixedly coupled to the first set of leg straps 340 at coupling location 342b. Similarly, the chest strap 348 may be fixedly coupled to the second set of leg straps 344 at coupling location 346b. In this manner, the chest strap 348 may be fixedly coupled to both of the first set of leg straps 340 and second set of leg straps 344.

In some embodiments, the chest strap 348 is fixedly coupled to the pet garment 300 along a substantial length of the chest strap 348. For example, there may be stitching or an adhesive extending along the length of the chest strap 348 between coupling point 342b and coupling points 346b that fixedly couples the chest strap 348 to the pet garment 300. In other embodiments, the chest strap 348 is at least partially moveable relative to the pet garment 300. For example, the chest strap 348 may be fixedly coupled to the pet garment 300 at coupling locations 342b and 346b such that the portion of the chest strap 348 that extends between the two locations 342b and 346b may be able to move relative to the pet garment 300.

In some embodiments, the straps included in the harness 330 (e.g., the back straps 332, 334, leg opening straps 340, 344, and chest strap 348) are comprised of a generally non-stretchable material. In some embodiments, the straps included in the harness 330 are comprised of a woven material (e.g., a woven nylon). In some embodiments, each of the straps included in the harness 330 are comprised of the same material.

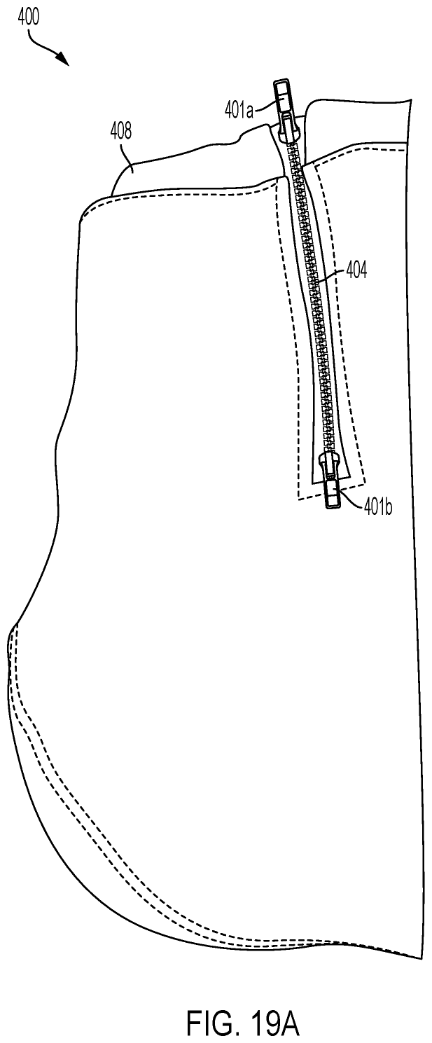

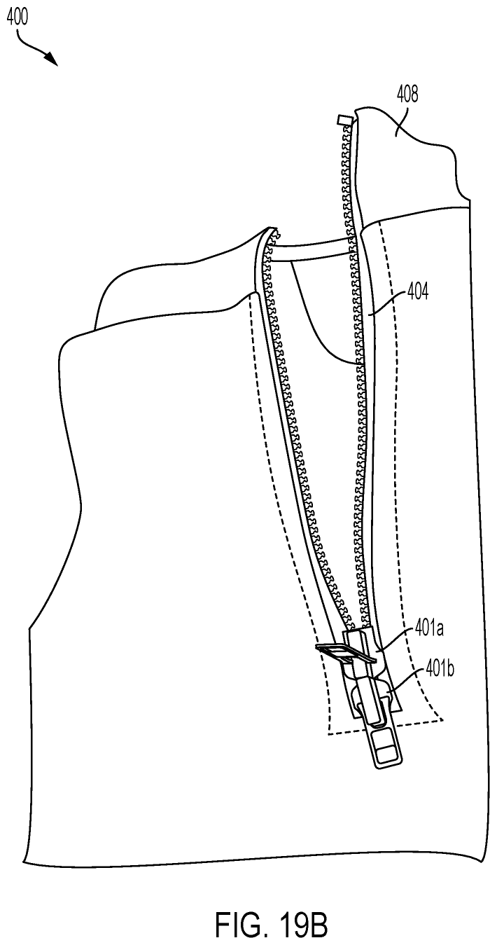

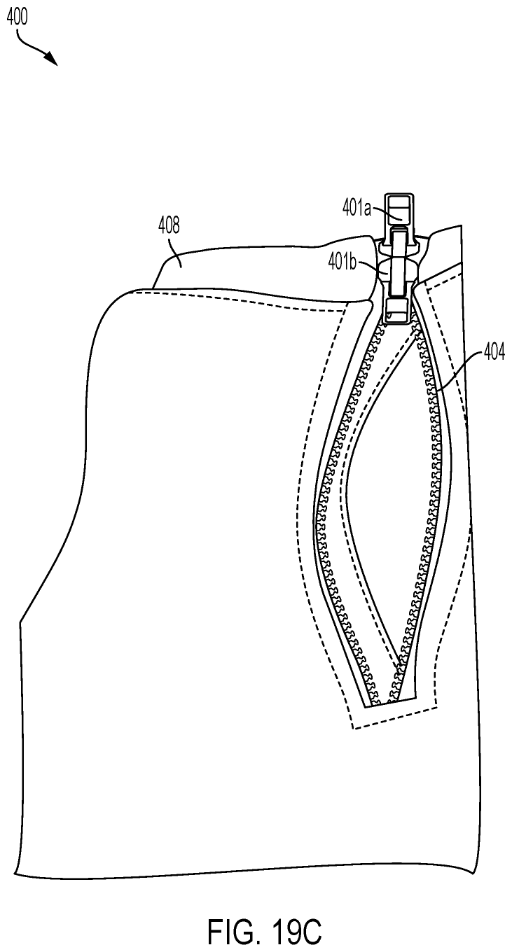

Referring to FIGS. 19A-19C there is shown a pet garment, generally designated 400, in accordance with another exemplary embodiment of the present invention. The pet garment 400 may be generally the same as pet garment 100 discussed above except it may include a double-sided zipper 404 and/or it may not include a fastener 122, cover 109 and reinforced portion 124. For example, the pet garment 400 includes a zipper 404 having a first slider 401a and a second slider 401b. When the zipper 404 is closed (e.g., as shown in FIG. 19), the first slider 401a may be positioned at the collar 408 of the pet garment 400 and the second slider 401b may be positioned on the zipper 404 opposite the first slider 401a. In some embodiments, movement of either of the sliders 401a-401b is limited by the zipper 404. For example, the first slider 401a may be moveable along the zipper 404 to the proximal end of the collar 404. As such, the first slider 401a may not be moveable proximally past the proximal end of the zipper 404 and away from the pet garment 400.

The sliders 401a and 401b may be moveable along the zipper 404 independent of one another. For example, the first slider 401a may be moved distally along the zipper 404 away from the collar 408 toward the second slider 401b as shown in FIG. 19B. Similarly, the second slider 401b may be moved proximally along the zipper 404 toward the collar 408 as shown in FIG. 19C. The first slider 401a may be configured to aid a user in positioning a pet within the pet garment 400. For example, a user slide the first slider 401a distally toward the second slider 401b to thereby widening the opening for the pet's head at the collar 408. In this manner, a user to more easily position a pet within the pet garment 400. The second slider 401b may be configured to enable a user to attach a leash or lead to a harness that the pet is wearing underneath the pet garment 400. For example, when a pet is positioned within the pet garment 400, the user may slide the second slider 401b toward the first slider 401a thereby creating an opening in the pet garment 400 that a leash or lead may pass through and couple to a harness the pet is wearing.

In some embodiments, the first and/or second sliders 401a-401b may be configured to keep the collar 408 closed while the leash or lead is attached to the pet without the aid of the fastener 122 as discussed above with reference to FIGS. 1-3C or the fasteners described with reference to FIGS. 4A-4B. For example, a leash or lead may be attached to the pet while the first slider 401a and second slider 401b are positioned along the zipper 404 proximate the collar 408 (as shown in FIG. 19C). As such, slider 401a and/or slider 401b may retain the collar 408 in a closed configuration (e.g., as shown in FIGS. 19A and 19C) without requiring the fastener 122. However, it should be understood that any one of the pet garments 100 or 300 may include a double-sided zipper similar to the zipper 404.

In some embodiments, one or more of the pet garments 100, 300, and/or 400 may include reflective material(s) positioned along one or more areas of the respective pet garment 100, 300, and/or 400. The reflective materials may increase the visibility of a pet wearing the pet garment 100, 300, and/or 400 during use in low visibility environments (e.g., at night, early morning prior to the sun rising). In some embodiments, there is a reflective material positioned along one or more of the seams of the pet garment 100, 300, and/or 400.

The broken lines in FIGS. 1-2, 6-8, and 14-16 may depict stitching and/or seams of the pet garments 100 and 300 with the exception of the broken lines representing the various distances, dimensions and axes described above. In some embodiments, there may be one or more reflective portions that extends at least partially along the seams and/or are positioned proximate the seams. The reflective portions may be disposed on the outer surface of the pet garments 100, 300, and/or 400 such that they may reflect light generated by an external source (e.g., car headlights). In some embodiments, there may be reflective portions/materials, positioned proximate the leg openings, zipper, collar, and/or tapered section of any one of the pet garments 100, 300, and/or 400. In some embodiments, one or more portions of the harness 330 of pet garment 300 may include a reflective material.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. As used herein, the term “about” may refer to +/−10% of the value referenced. For example, “about 9” is understood to encompass 8.1 and 9.9.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A pet garment comprising:
a first panel configured to cover a back of a pet;
a second panel fixedly coupled to the first panel, the second panel including two leg openings configured to receive front legs of the pet, the second panel configured to cover a portion of a neck and chest of the pet;
a collar fixedly coupled to the first panel and second panel, the collar including a first segment and a second segment and configured to extend around a portion of the pet's neck;
a zipper coupled to the collar and first panel, the zipper extending along the collar and at least partially along the first panel;
a cover releasably covering a portion of the zipper which extends along the collar; and
a fastener including a first cap fixedly coupled to the cover and a receiving socket fixedly coupled to the first segment of the collar,
wherein the first segment of the collar has an elasticity that is less than an elasticity of the second segment.

2. The pet garment of claim 1, wherein the first segment comprises between about 5% to about 10% of a total length of the collar.

3. The pet garment of claim 1, wherein the first segment is directly coupled to a portion of the zipper.

4. The pet garment of claim 1, wherein the fastener is a spring snap ring fastener.

5. The pet garment of claim 1, wherein the cover has an elasticity that is less than the elasticity of the second segment of the collar.

6. The pet garment of claim 1, wherein the second segment of the collar is comprised of about 85% nylon and about 15% elastane.

7. The pet garment of claim 1 further comprising:
a second cap fixedly coupled to the cover and spaced from the first cap.

8. The pet garment of claim 1, wherein the first panel and second panel are comprised of different materials.

9. The pet garment of claim 1, wherein the two leg openings are configured to allow the front legs of a pet to pass through while not exposing additional areas of the pet.

10. The pet garment of claim 1, wherein the two leg openings are disposed at an angle relative to a top surface of the first panel, the angle being between about 5 degrees and about 15 degrees.

11. The pet garment of claim 1, wherein each of the two leg openings include an upper edge and a lower edge, the lower edge having a greater elasticity than the upper edge.

12. The pet garment of claim 1, wherein the two leg openings include an upper edge and a lower edge, the lower edge having a radius of curvature that is less than a radius of curvature of the upper edge.

13. The pet garment of claim 1, wherein the second panel has an elasticity that is greater than an elasticity of the first panel.

14. A pet garment comprising:
a first panel configured to cover a back of a pet and comprised of a fleece fabric;
a second panel fixedly coupled to the first panel and comprised of an elastomeric material, the second panel including two leg openings configured to receive front legs of a pet while not exposing additional areas of the pet, the second panel configured to cover a portion of a neck and chest of the pet;
a collar fixedly coupled to the first panel and a second panel, the collar including a first segment and a second segment and configured to cover a portion of the pet's neck;
a zipper coupled to the collar and the first panel, the zipper extending from the collar and along a portion of a length of the first panel;
a cover releasably covering a portion of the zipper which extends along the collar; and
a spring snap ring fastener including a first cap fixedly coupled to the cover and a receiving socket fixedly coupled to the first segment of the collar,
wherein the first segment of the collar and the cover each have an elasticity that is less than an elasticity of the second segment.

15. The pet garment of claim 14, wherein the first segment comprises between about 5% to about 10% of a total length of the collar.

16. The pet garment of claim 14, wherein the first segment is directly coupled to a portion of the zipper.

17. The pet garment of claim 14, wherein the second segment of the collar is comprised of about 85% nylon and about 15% elastane.

18. The pet garment of claim 14, wherein the first segment of the collar is comprised of a non-elastic material.

19. The pet garment of claim 14 further comprising:
a second cap fixedly coupled to the cover and spaced from the first cap.

20. A pet garment comprising:
a first panel configured to cover a back of a pet;
a second panel fixedly coupled to the first panel, the second panel including two leg openings configured to receive front legs of the pet, the second panel configured to cover a portion of a neck and chest of the pet;
a collar fixedly coupled to the first panel and second panel, the collar including a first segment and a second segment and configured to extend around a portion of the pet's neck; and
a double-sided zipper coupled to the collar and first panel and extending from the collar along a portion of a length of the first panel, the double-sided zipper including a first slider and second slider movable along the double-sided zipper independent of one another.
